(19) United States
(12) Patent Application Publication
(10) Pub. No.: US 2011/0048630 A1
(43) Pub. Date: Mar. 3, 2011

(54) PROTECTIVE TAPE SEPARATING METHOD AND APPARATUS

(76) Inventors: Yukitoshi Hase, Kameyama-shi (JP); Masayuki Yamamoto, Osaka (JP)

(21) Appl. No.: 12/847,858

(22) Filed: Jul. 30, 2010

(30) Foreign Application Priority Data
Aug. 31, 2009 (JP) 2009-200316

(51) Int. Cl. B32B 38/10

(52) U.S. Cl. 156/272.2; 156/344; 156/584

(57) ABSTRACT

A chuck table adhesively holds a rear face of a mount frame subject to a dicing process with a protective tape joined thereto, and a suction plate having a heater embedded therein contacts and heats the protective tape. Consequently, an adhesion layer of the protective tape reduces its adhesive force due to foaming and expansion. Thereafter, the suction plate moves upward while keeping its suction force to separate the protective tape from all of chips.

### BACKGROUND OF THE INVENTION

1. Field of the Invention

This invention relates to a protective tape separating method and apparatus to separate a protective tape that protects a circuit surface of a substrate such as a semiconductor wafer, a circuit board, and an electron device (for instance, an LED (Light-emitting diode) and a CCD (charge coupled device).) More particularly, this invention is directed to a technique of separating the protective tape from chips produced after dicing of the substrate into a given shape.

2. Description of the Related Art

Typically, numerous components are formed on a surface of a semiconductor wafer (hereinafter simply referred to as a “wafer”), and then grinding is performed to a rear face of the wafer in a back grinding process. Next, the wafer is diced into each component in a dicing process. The wafer tends to be thinned to have a thickness of 100 μm to 50 μm or even less in recent years with a need for a high density package.

Here, the protective tape is joined to the surface of the wafer upon thinning of the wafer in the back grinding process for the purposes of protection of the circuit surface of the wafer, prevention of the wafer from being subject to grinding stress upon back grinding, and reinforcement of the thinned wafer through the back grinding.

After the back grind process, a separation adhesive tape is joined to the protective tape on the wafer in a mount frame that is adhesively held on a ring frame via a dicing tape. Thereafter, the separation adhesive tape is separated, thereby separation of the protective tape from the surface of the wafer together with the separation adhesive tape. See Japanese Patent Publication No. 2006-165385.

The above conventional method, however, has the following problem. That is, in the conventional method of separating the protective tape, not only the protective tape but the thinned wafer is possibly pulled up and bent forward due to tension that acts on a separation portion of the separation tape upon separation thereof. The wafer may be damaged under such state.

Moreover, it becomes impossible to reinforce the wafer having reduced rigidity sufficiently only via the dicing tape with respect to the thinned wafer even though the wafer is adhesively held on the dicing tape. As a result, a new problem arises that the wafer is readily damaged during a step of transporting the mount frame into a dicing process.

### SUMMARY OF THE INVENTION

This invention has one object to separate a protective tape with no damage to a substrate.

Additional features of the invention will be set forth in the description which follows, and in part will be apparent from the description, or may be learned by practice of the invention.

The invention discloses a method of separating a protective tape joined to a surface of a substrate. The method includes the steps of reducing an adhesive force of the protective tape joined to the chips into which the substrate having the protective tape joined thereto is diced in a given shape, and separating the protective tape having a reduced adhesive force from the surface of the substrate while suction-holding an entire surface of the substrate.

With the protective tape separating method of this embodiment, the protective tape is joined to the surface of the substrate from the back grinding process to the process of dicing the substrate into the chips, which results in reinforcement of the substrate. Therefore, damages to the substrate may be suppressed that are likely to occur from the back grinding process to the dicing process.

Moreover, the protective tape having a reduced adhesive force is separated from the chips. Thus, damages may also be suppressed that are likely to occur upon separation of the protective tape from the thinned substrate of large size. Specifically, the protective tape joined to the chips has a contact area extremely smaller than an area of the protective tape joined to the entire surface of the substrate, which results in a remarkably reduced separation stress on the chips upon separation. Consequently, damages to the chips may be suppressed that occur due to separation stress. The adhesive force in this invention is not limited to that to be reduced, but includes that to be eliminated.

In the method noted above, the step of reducing the adhesive force may include contacting a suction plate provided with a heater to the protective tape having an adhesion layer of thermal foam and heating the protective tape while suction-holding thereof. Moreover, the step of separating the adhesive tape may include suction-holding the protective tape having a reduced adhesive force due to thermal foaming by a suction mechanism for separation and removal of the protective tape.

According to the method of this embodiment, the adhesive force in the adhesion layer of thermal foam is reduced due to heating, and thereafter the protective tape is suction-held by the suction mechanism. Consequently, the protective tape is separated and removed from the chips. Therefore, the protective tape may be removed with high accuracy with no residue of the protective tape on the chips.

In the foregoing method, the step of reducing the adhesive force may include contacting a suction plate provided with a heater to the protective tape configured so as to bend backward in a given uniaxial direction to thermally shrink the protective tape, and moving the suction plate upward and increasing a suction force as a heat shrinkage rate of the protective tape increases. Moreover, the step of separating the protective tape may include suction-holding the protective tape with the suction plate for separation and removal of the protective tape.

According to the method of this embodiment, the protective tape diced into a same shape as the chips may bend backward in a uniaxial direction regularly. Consequently, dispersion of the protective tape may be suppressed that is likely to occur when bending in various directions. Moreover, the suction plate moves upward as the protective tape thermally shrinks. Consequently, pressure to the chips may be suppressed that acts with the protective tape bending backward between the chips and the suction plate. In addition, the suction force of the suction plate to the protective tape also increases as the heat shrinkage rate increases. Therefore, separation and removal of the protective tape may surely be realized while promoting separation of the protective tape from the chips.

In the foregoing method, the step of reducing the adhesive force may include irradiating an ultraviolet curable protective tape with ultraviolet rays. Moreover, the step of separating the protective tape may include suction-holding the protective tape having a reduced adhesive force due to ultraviolet irradiation with the suction plate for separation and removal of the protective tape.

According to the method of this embodiment, the adhesion layer of the protective tape is cured with ultraviolet irradiation, which results in a reduced adhesive force therein.

In the foregoing method, the step of reducing the adhesive force may also include contacting a permeable suction plate provided with an ultraviolet irradiation unit to the protective tape and irradiating the protective tape with ultraviolet rays while suction-holding the protective tape by the suction plate.

With the method of this embodiment, ultraviolet rays are applied to the protective tape with the protective tape sandwiched and suction-held between the suction plate and the chips. Consequently, the protective tape having a reduced adhesive force may surely be separated from the chips with no protective tape being dispersed.

This invention adopts the configuration as stated below to accomplish the above object. This invention discloses a protective tape separation apparatus to separate a protective tape joined to a surface of a substrate. The apparatus includes a chuck table to suction-hold the substrate formed of diced chips in a given shape with the protective tape joined thereto, an adhesive force reduction device to reduce an adhesive force in the protective tape, and a separation mechanism to separate the protective tape having a reduced adhesive force from the chips.

According to the configuration of this embodiment, the adhesive force reduction device may reduce the adhesive force in the protective tape on the surface of the chuck table with the chips over the entire surface of the substrate prior to dicing suction-held on the chuck table. Thereafter, the protective tape is separated and removed from the chips.

In the foregoing configuration, the protective tape preferably has an adhesion layer of thermal foam, and the adhesive force reduction device is preferably a heater.

In the foregoing configuration, the heater is preferably embedded in the suction plate.

With this configuration, the protective tape on the surface of the chuck table may be heated with two or more chips held on the chuck table sandwiched and suction-held by the suction plate. Consequently, the protective tape having a reduced adhesive force due to heating may immediately be suction-held and separated for removal with no protective tape dispersed.

In the foregoing configuration, the protective tape is preferably formed so as to bend backward in a given uniaxial direction, and the adhesive force reduction device is preferably a heater.

Moreover, in this configuration, it is preferable to embed the heater in the suction plate. Furthermore, it is preferable to include a controller. The controller contacts the suction plate to the protective tape for thermal shrinkage of the protective tape, and moves the suction plate upward and increases a suction force as a heat shrinkage rate increases.

In the foregoing configuration, the protective tape is preferably an ultraviolet curable adhesive tape, and the adhesive force reduction device is preferably an ultraviolet irradiation unit.

In addition, the adhesive force reducing device of this configuration preferably further provides the ultraviolet irradiation unit in the suction plate.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a perspective view of a mount frame.

FIG. 2 is a plan view of a protective tape separation apparatus.

FIG. 3 is a front view of the protective tape separation apparatus.

FIG. 4 is a front view of a cassette mounting section.

FIG. 5 is a plan view of a first transport mechanism.

FIG. 6 is a front view of the first transport mechanism.

FIG. 7 is a front view of a chuck table.

FIG. 8 is a side view of a tape separation mechanism.

FIGS. 9 to 12 are explanatory views each showing operation of a holding table.

FIG. 13 is a sectional view of a protective tape in accordance with one modification.

FIG. 14 is an explanatory view showing separation of the protective tape in accordance with one modification.

FIG. 15 is a front view of a modified apparatus using an ultraviolet curable protective tape.

### DESCRIPTION OF THE PREFERRED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

One embodiment of this invention will be described hereunder with reference to the drawings.

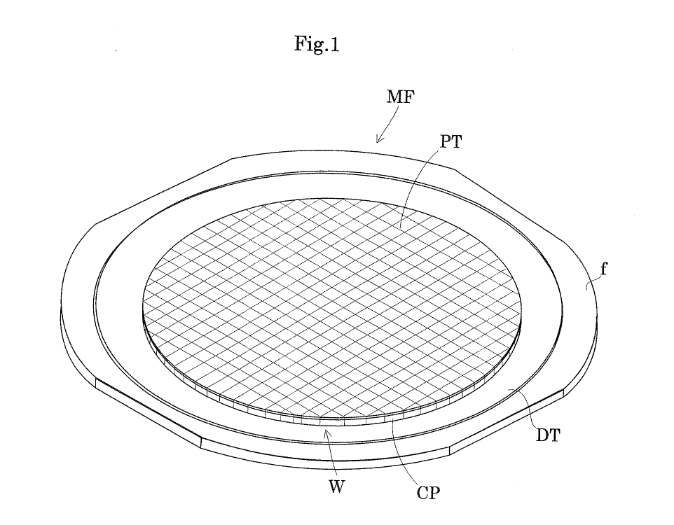

In this embodiment, a semiconductor wafer is to be described by way of example as a substrate. As shown in FIG. 1, a semiconductor wafer W (hereinafter simply referred to as a “wafer W”) is subject to back grinding and dicing processes with a protective tape PT joined thereto that protects a circuit pattern on the wafer W, and diced into chips CP. Two or more chips CP are adhesively held on a ring frame f via an adhesive tape DT (dicing tape), and processed as a mount frame MF.

Here, the protective tape PT has an adhesion layer of thermal foam in a tape base material that loses its adhesive force due to foaming and expansion through heating.

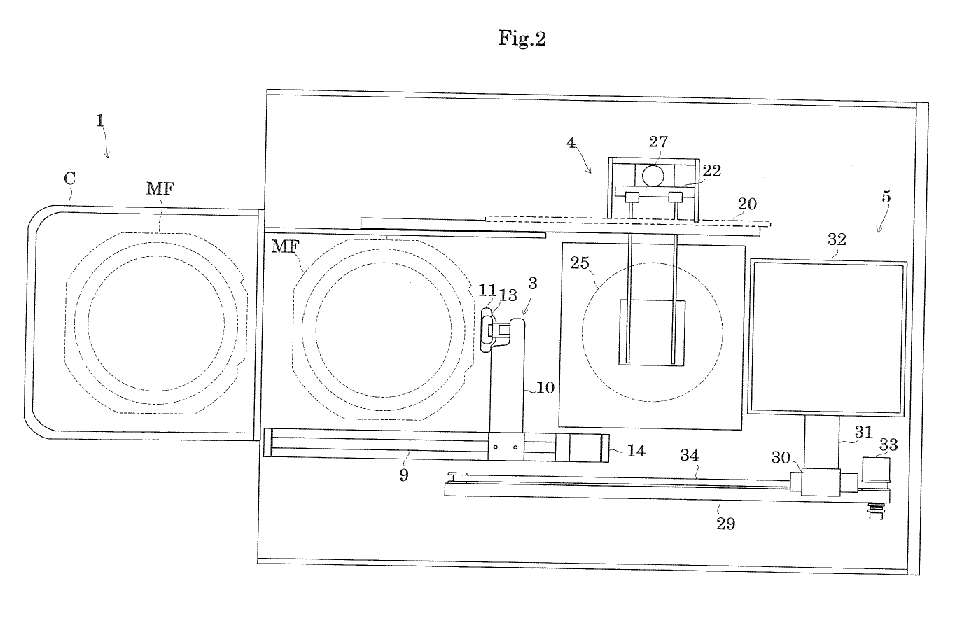

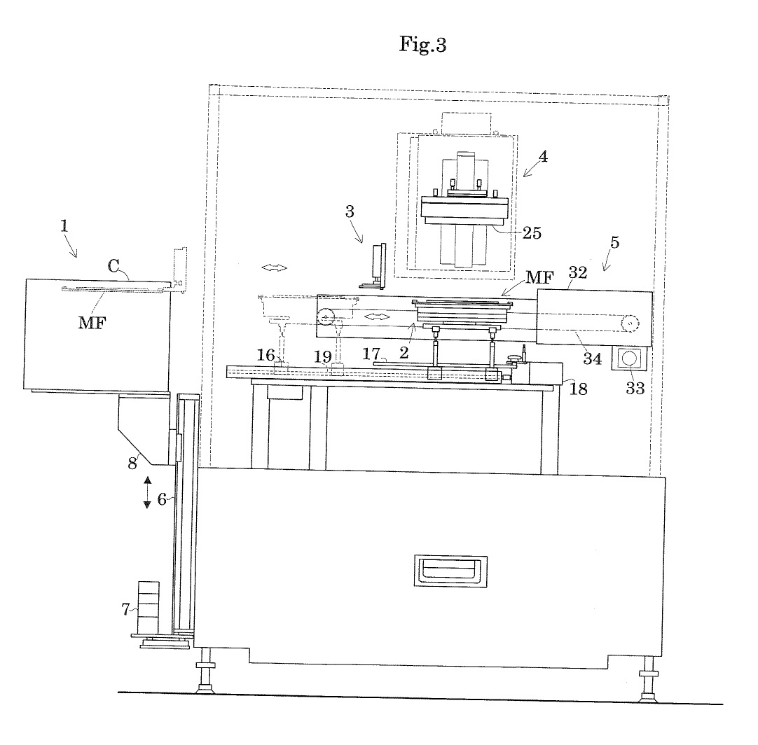

FIGS. 2 and 3 show a schematic configuration of a protective tape separation apparatus and a process of separating a protective tape for accomplishing the method according to this invention.

The protective tape separation apparatus is formed of a cassette mounting section 1, a first transport mechanism 3, a tape separation mechanism 4, and a tape collecting mechanism 5. The cassette mounting section 1 has a cassette C mounted thereon that houses mount frames MF at a predetermined pitch in a stack manner. The first transport mechanism 3 pulls out the mount frame MF from the cassette C and places the mount frame MF on a chuck table 2, and houses the mount frame MF with the protective tape PT separated therefrom into the cassette C. The tape separation mechanism 4 separates the protective tape PT from chips CP diced in a given size. The tape collecting mechanism 5 collects the protective tape PT that is separated from the chips CP. Each configuration will be described in detail hereinafter.

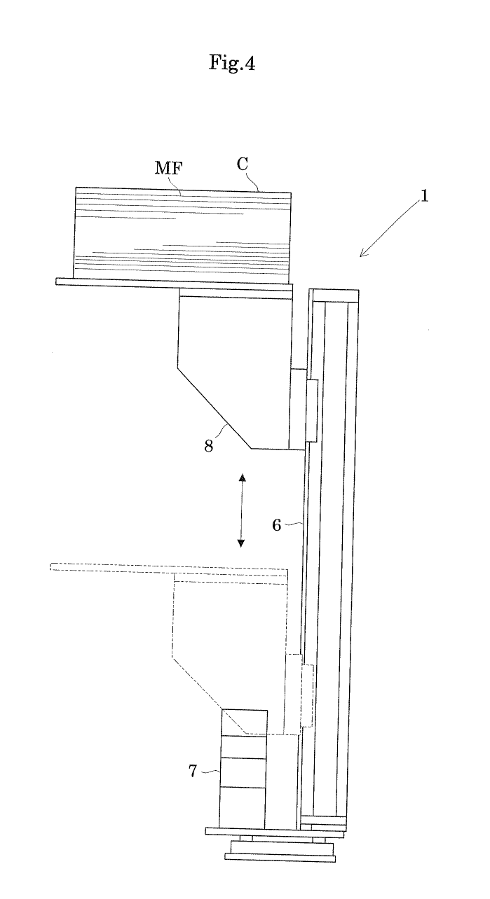

The cassette mounting section 1 has an upright rail 6 and a lifting table 8, as shown in FIG. 4. The upright rail 6 is fixedly coupled to an apparatus framework. The lifting table 8 moves upward and downward in a screw-feed manner by a drive mechanism 7 such as a motor along the upright rail 6. Accordingly, the cassette mounting section 1 allows the mount frame MF placed on the lifting table 8 to move vertically in a pitch feed manner.

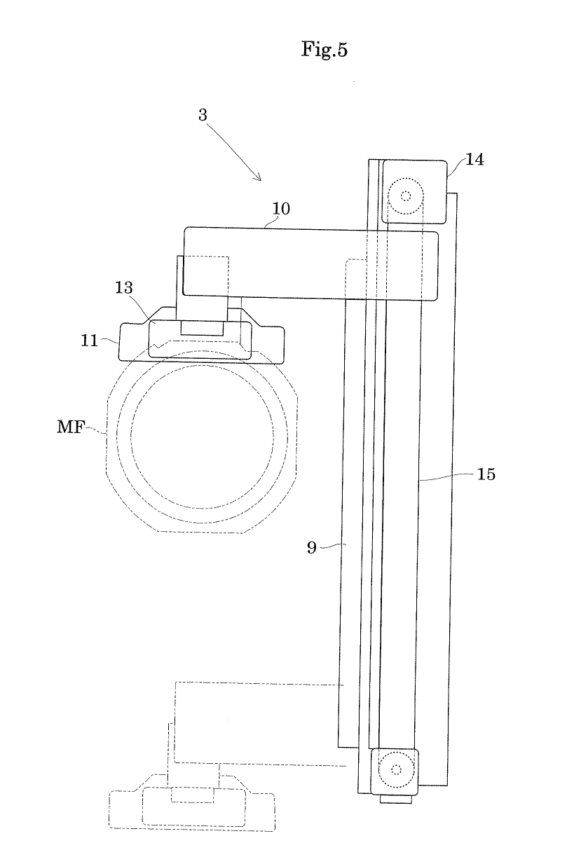

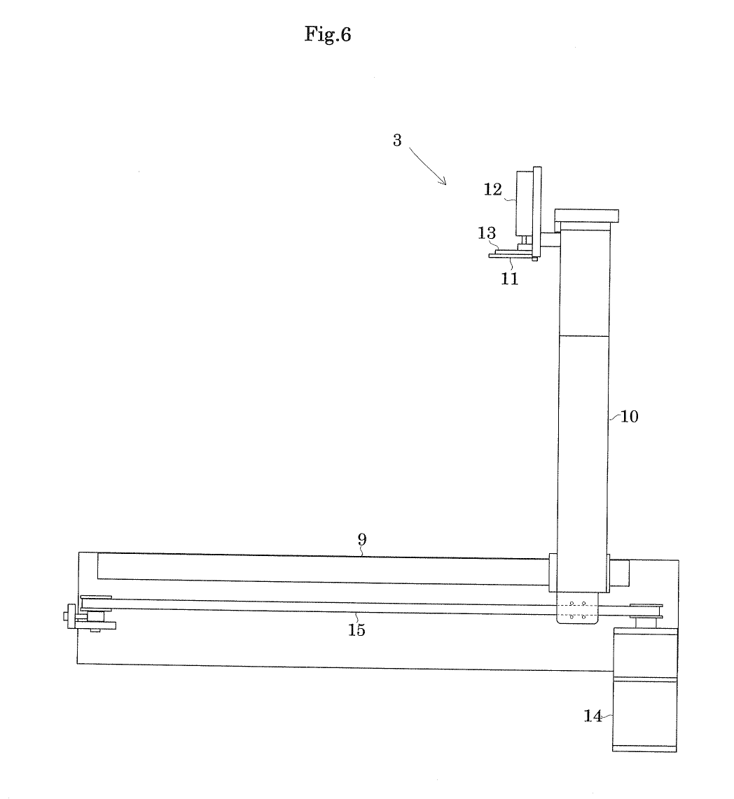

As shown in FIGS. 5 and 6, the first transport mechanism 3 has a movable table 10 and a chuck piece 13 provided on the movable table 10 that moves horizontally along a guide rail 9. A fixed receiving piece 11 and a cylinder 12 open and close the chuck piece 13. The fixed receiving piece 11 and the chuck piece 13 vertically grasp one end of the mount frame MF. Moreover, the movable table 10 has a bottom coupled to a belt 15 that is turned by a motor 14. When the motor 14 operates forward and backward, the movable table 10 reciprocates in a horizontal direction.

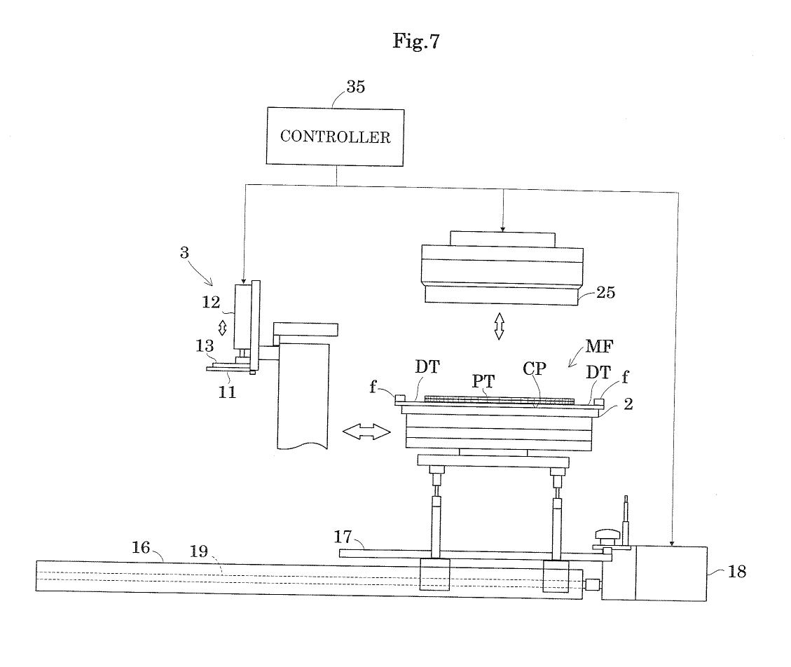

As shown in FIG. 7, the chuck table 2 performs vacuum suction on a rear face of the mount frame MF. The chuck table 2 is supported by a movable table 17 capable of slidingly moving backward and forward along a pair of rails 16 that are arranged horizontally in parallel. The movable table 17 is driven in a screw feed manner via a screw shaft 19. The screw shaft 19 is driven by a pulse motor 18 so as to rotate backward and forward. That is, the chuck table 2 reciprocates from a position of receiving the mount frame MF to a position of separating the protective tape PT.

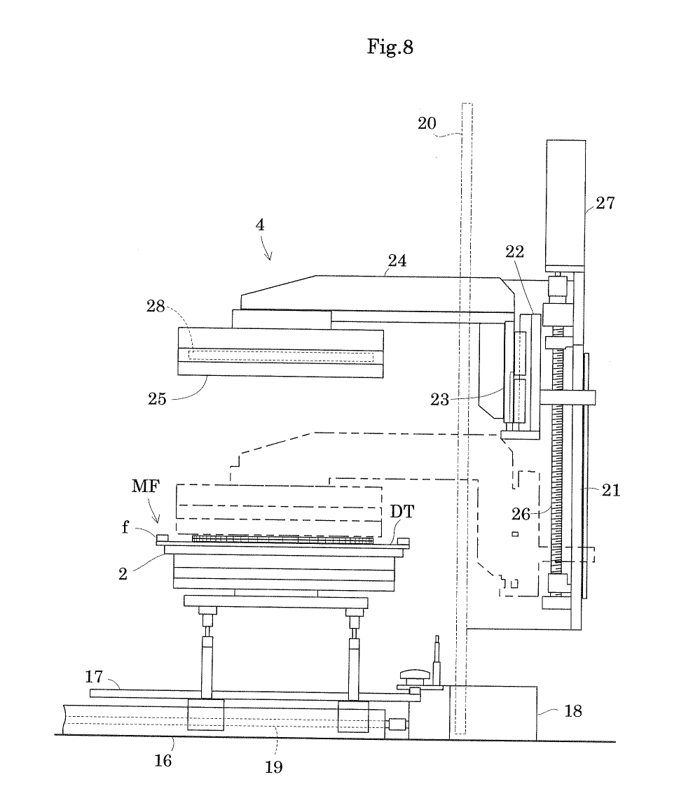

As shown in FIG. 8, the tape separation mechanism 4 has a movable table 22, a movable frame 23, and a suction plate 25. The movable table 22 moves upward and downward along a rail 21 arranged vertically at a backside of a wall 20. The movable frame 23 is supported on the movable table 22 so as to control a level thereof. The suction plate 25 is provided at a tip end of an arm 24 that extends forward from the movable frame 23. The movable table moves upward and downward in a screw feed manner by backward and forward rotation of a screw shaft 26 by a motor 27. The suction plate 25 has an undersurface formed as a vacuum suction surface, and a heater 28 embedded therein. Here, the tape separation mechanism 4 corresponds to the separation mechanism of this invention.

As shown in FIGS. 2 and 3, the tape collecting mechanism 5 has a collection box 32 provided on an arm 31. The arm 31 extends from the movable table 30 that moves horizontally along a guide rail 29. Moreover, the movable table 30 is coupled to a belt 34 that is turned by a motor 33. When the motor 33 operates forward and backward, the movable table 30 reciprocates in a horizontal direction.

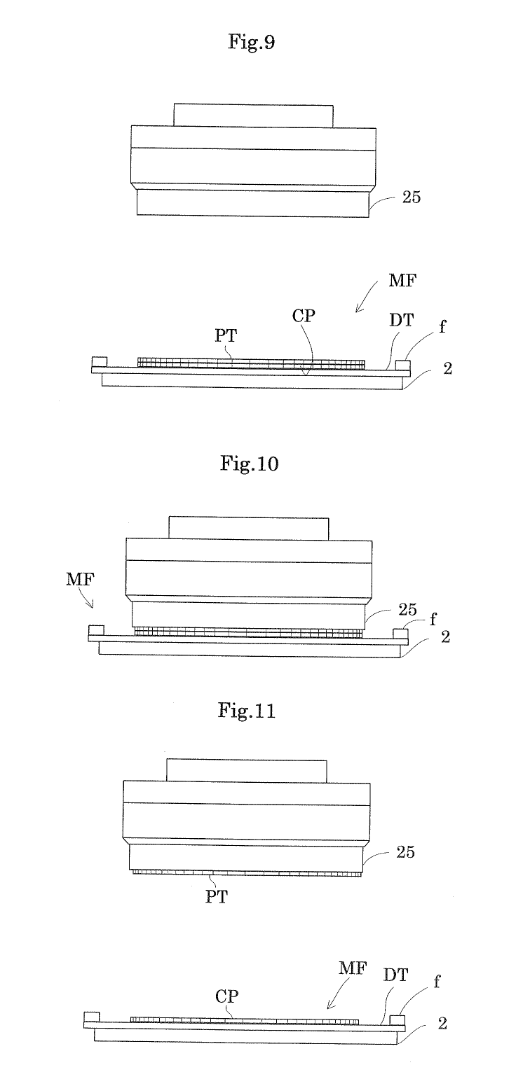

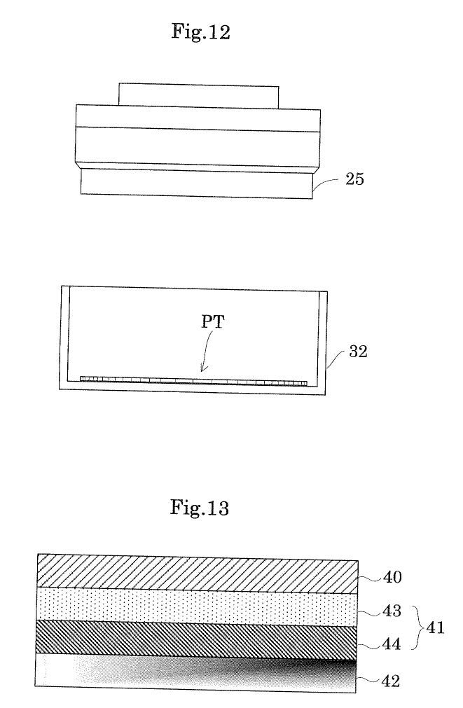

Next, with reference to FIGS. 9 to 12, description will be given of a series of basic operations for separating the protective tape PT from the surface of the wafer W using the apparatus in the foregoing embodiment.

The first transport mechanism 3 is in a standby position at a center in FIG. 2, and moves to a position of pulling out the mount frame MF. The first transport mechanism 3 pulls out the mount frame MF from the cassette C while holding the mount frame MF and moving backward. Here, the mount frame MF is housed in the cassette C in a stack manner with the surface of the wafer W directed upward. In this state, the chuck table 2 moves from a separating position below the protective tape separation mechanism 4 to a position of receiving the mount frame MF and in a standby condition.

The first transport mechanism 3 stops in a standby position, and then moves downward to open the chuck piece 13. Consequently, the mount frame MF is moved and placed on the chuck table 2.

The chuck table 2 moves to the separating position while suction-holding the entire rear face of the mount frame MF.

Upon reaching of the chuck table 2 to the separation position as in FIG. 9, the tape separation mechanism 4 operates to move downward the suction plate 25 for suction-holding the protective tape PT as in FIG. 10. In this state, the heater 28 heats the suction plate 25. The adhesion layer of the protective tape PT is foamed and expands as the suction plate 25 is heated. Consequently, the adhesion layer reduces its adhesive force gradually.

The controller 35 in FIG. 7 controls the tape separation mechanism 4 so as to move upward intermittently or continuously during a heating process in accordance with types of adhesion layers used for the protective tape PT, heating temperatures, and variations in thickness of the protective tape PT determined in advance from durations for heating. Specifically, the adhesive tape has an increased thickness due to foaming and expansion of the adhesion layer. Thus, the suction plate 25 is controlled to move upward with no damage to the thinned chips CP due to excessive pressure on the chips CP that is sandwiched between the suction plate 25 and the chuck table 2.

Upon completion of heating and foaming processes to the adhesion layer, the suction plate 25 moves upward to a given level while suction-holding the protective tape PT, as shown in FIG. 11. Here, the chuck table 2 moves to a position of transporting the mount frame MF while the suction plate 25 suction-holds the mount frame MF in which the protective tape PT is separated from all of the chips CP. At this time, the tape collecting mechanism 5 operates to move the collecting box 32 from the standby position to the separating position.

Upon reaching of the chuck table 2 to a position of receiving the mount frame MF, the chuck piece 13 of the first transport mechanism 3 holds the processed mount frame MF, and transports the mount frame MF from the chuck table 2 to house the mount frame MF in an original position in the cassette C. Upon completion of housing, the lifting table 8 moves upward by a given pitch and the first transport mechanism 3 transports a new mount frame MF.

Upon reaching of the collecting box 32 to the separation position, the suction plate 25 releases its suction to drop all of the protective tape PT separated from the chips CP into the collecting box 32.

A series of operations are completed as noted above. The same process as above is to be repeatedly performed to every mount frame MF housed in the cassette C.

With the foregoing configuration, the wafer W adhesively held on the mount frame MF after subject to the back grinding process is transported in the separating process. Here, the dicing process has been performed to the wafer W with the protective tape joined thereto. Therefore, treatment may be easily performed to the mount frame MF having increased rigidity due to reinforcement compared with the conventional mount frame MF after separating the protective tape therefrom. Therefore, damages to the wafer W may be suppressed that are likely to occur during a transport step from the back grinding process to the dicing process.

Moreover, the protective tape PT having a reduced adhesive force is separated from the chips CP. Thus, damages may also be suppressed that are likely to occur upon separation of the protective tape PT from the entire surface of the thinned wafer W of large size. Specifically, the protective tape PT joined to the chips CP has a contact area extremely smaller than an area of the protective tape PT joined to the entire surface of the wafer, which results in a remarkably reduced separation stress on the chips CP. Consequently, damages to the chips CP or scattering of the protective tape PT may be suppressed that occur due to the separation stress.

This invention is not limited to the foregoing embodiment, but may be modified as follows.

The protective tape PT may be adopted that includes an adhesion layer having a heat-shrinkable property capable of bending in a given uniaxial direction upon heating.

Specifically, as shown in FIG. 13, the protective tape PT may be a self-rolling pressure-sensitive adhesive sheet formed of a laminate having a shrinkable film layer 40 of a uniaxial shrink property, a restraint layer 41, and an adhesion layer 42. Here, the restraint layer 41 restrains shrinkage of the shrinkable film layer 40.

The restraint layer 41 is formed of a flexible layer 43 on a shrinkable film layer 40 side and a rigid film layer 44 on an opposite side of the shrinkable film layer 40 side.

The shrinkable film layer 40 may be just a film layer having a shrink property in at least a uniaxial direction. Moreover, the shrinkable film layer 40 may be formed of any one of a heat-shrinkable film, a film shrinkable with light, and a film shrinkable with electric stimulation. The shrinkable film layer 40 may be a single layer, or a multiple layer composed of two or more layers.

The restraint layer 41 restrains shrinkage of the shrinkable film layer 40 to produce a reactive force. Consequently, couple of forces arises throughout the laminate, which leads to rolling up of the protective tape PT. Moreover, the restraint layer 41 may suppress secondary shrinkage in a direction different from a main shrinking direction of the shrinkable film layer 40. Here, the shrinking direction of the shrinkable film layer 40 is not always uniform although it is uniaxial. Thus, the restraint layer 41 has also a function to converge the shrinking direction of the shrinkable film layer 40 into one direction. As a result, upon applying of stimulation such as heat to the laminate for promoting shrinkage of the shrinkable film layer 40, a reactive force is developed against the shrinkage stress of the shrinkable film layer 40 in the restraint layer 41. The reactive force serving as a driving force floats an outer periphery of the laminate (a first end or a second end on the other side.) The protective tape self-rolls from the end thereof to one or a central direction (typically, a main shrinkage direction of the heat shrinkable film), thereby forming a cylindrical roll. The restraint layer 41 may avoid transmitting of shearing stress to the adhesion layer 42 or chips CP that is produced due to the shrinkage deformation of the shrinkable layer 40. Consequently, the chips CP may be prevented from being damaged or contaminated.

The flexible layer 43 may be made from a material that is likely to be deformed under a temperature where the shrinkable film layer 40 shrinks. For instance, the flexible layer 43 is preferably rubbery.

Upon applying of rigidity or toughness in the restraint layer 41, the rigid film layer 44 produces a reactive force against the shrinking force of the shrinkable film layer 40. In addition, the rigid film layer 44 produces couple of forces required for rolling. Thus, stimulation such as heat as a cause of shrinkage is applied to the shrinkable film layer 40 having the rigid film layer 44, the laminate layer may self-roll smoothly with no stopping in its track or no offset. As a result, a cylindrical roll in a uniform shape can be formed.

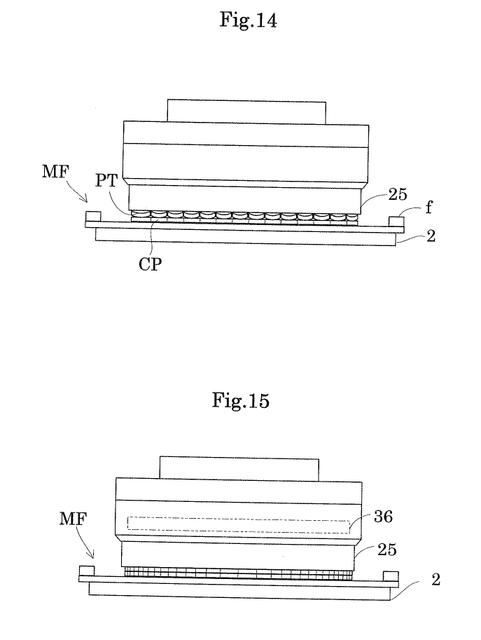

Here, when two or more pieces of the protective tape PT cut in a size of given chip CP are heated through the suction plate 25, each piece of the protective tape PT bends upward from right and left ends thereof, as shown in FIG. 14. Accordingly, the controller 35 controls the tape separation mechanism 4 so as to move upward intermittently or continuously during the heating process in accordance with types of adhesion layers used for the protective tape PT, heating temperatures, and variations in thickness of the protective tape PT determined in advance from and durations for heating, which is similar to the foregoing embodiment. In addition, a suction force of the suction plate 25 is controlled so as to increase simultaneously.

Specifically, the protective tape PT bends backward, and a distance in a height direction increases. Thus, the suction plate 25 is controlled to move upward with no damage to the thinned chips CP due to excessive pressure on the chips CP that is sandwiched between the suction plate 25 and the chuck table 2. In addition, the suction force of the suction plate 25 is controlled so as to increase in accordance with an amount of bending of the protective tape PT such that no contact area to the suction plate 25 reduces due to backward bending of the protective tape.

With this configuration, even when the protective tape PT bends backward and has an increased thickness in a height direction, no chip CP will be damaged and the protective tape may also be prevented from scattering due to poor suction.

In the foregoing embodiment, an ultraviolet curable adhesive tape may be adopted as the protective tape PT. In this case, as shown in FIG. 15, the suction plate 25 is formed of a permeable tempered glass or acrylics plate having suction holes in a position corresponding to each chip CP. Moreover, the suction plate 25 has a fluorescent tube 36 for ultraviolet irradiation arranged in an opposite side where the protective tape PT contacts. Here, the fluorescent tube 36 for ultraviolet irradiation corresponds to the ultraviolet irradiation unit of this invention.

The configuration of the ultraviolet irradiation unit is not be limited to a fluorescent tube, but may be an ultraviolet irradiation lamp or an LED. Where an LED is to be used, it is preferable to arrange a same number of LEDs as the chips CP in a two-dimensional array. With this configuration, uniform ultraviolet irradiation may be performed to the protective tape PT on each of the chips CP.

With this configuration, ultraviolet rays may be applied to the protective tape PT with the suction plate 25 contacting to the protective tape PT while sucking. When an adhesive force is reduced due to ultraviolet irradiation for a given duration, the suction plate 25 moves upward with the protective tape PT being suction-held, and thus the protective tape PT may be separated and removed collectively from all of the chips CP.

Each of the foregoing embodiments may be configured as follows. That is, the chuck table 2 and the suction plate 25 are reversed to obtain the protective tape PT directed downward. The suction plate 25 sucks the protective tape PT from the bottom for removal.

Here, another suction plate different from the suction plate 25 is arranged. The suction plate sucks the protective tape PT on the suction plate 25 that is separated from the chips CP for removal. The suction plate 25 may also be configured so as to reverse.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method of separating a protective tape joined to a surface of a substrate, comprising the steps of:
reducing an adhesive force of the protective tape joined to the chips into which the substrate having the protective tape joined thereto is diced in a given shape; and
separating the protective tape having a reduced adhesive force from the surface of the substrate while suction-holding an entire surface of the substrate.

2. The method of separating the protective tape according to claim 1, wherein
the step of reducing the adhesive force comprises contacting of a suction plate provided with a heater to the protective tape having an adhesion layer of thermal foam and heating of the protective tape while suction-holding thereof, and
the step of separating the adhesive tape comprises suction-holding of the protective tape having a reduced adhesive force due to thermal foaming by a suction mechanism for separation and removal of the protective tape.

3. The method of separating the protective tape according to claim 1, wherein
the step of reducing the adhesive force comprises contacting of a suction plate provided with a heater to the protective tape configured so as to bend backward in a given uniaxial direction to thermally shrink the protective tape, and moving of the suction plate upward and increasing of a suction force as a heat shrinkage rate of the protective tape increases, and
the step of separating the protective tape comprises suction-holding of the protective tape with the suction plate for separation and removal of the protective tape.

4. The method of separating the protective tape according to claim 1, wherein
the step of reducing the adhesive force comprises irradiating of an ultraviolet curable protective tape with ultraviolet rays, and
the step of separating the protective tape comprises suction-holding of the protective tape having a reduced adhesive force due to ultraviolet irradiation with the suction plate for separation and removal of the protective tape.

5. The method of separating the protective tape according to claim 4, wherein
the step of reducing the adhesive force comprises contacting of a permeable suction plate provided with an ultraviolet irradiation unit to the protective tape and irradiating of the protective tape with ultraviolet rays while suction-holding the protective tape by the suction plate.

6. A protective tape separation apparatus to separate a protective tape joined to a surface of a substrate, comprising:
a chuck table to suction-hold the substrate formed of diced chips in a given shape with the protective tape joined thereto;
an adhesive force reduction device to reduce an adhesive force in the protective tape; and
a separation mechanism to separate the protective tape having a reduced adhesive force from the chips.

7. The protective tape separation apparatus according to claim 6, wherein
the protective tape has an adhesion layer of thermal foam; and
the adhesive force reduction device is a heater.

8. The protective tape separation apparatus according to claim 7, wherein the heater is embedded in a suction plate.

9. The protective tape separation apparatus according to claim 6, wherein
the protective tape is formed so as to bend backward in a given uniaxial direction; and
the adhesive force reduction device is a heater.

10. The protective tape separation apparatus according to claim 9, further comprising a controller to contact the suction plate to the protective tape for thermal shrinkage of the protective tape, and to move the suction plate upward and increase a suction force as a heat shrinkage rate increases.

11. The protective tape separation apparatus according to claim 6, wherein
the protective tape is an ultraviolet curable adhesive tape; and
the adhesive force reduction device is an ultraviolet irradiation unit.

12. The protective tape separation apparatus according to claim 11, wherein
the adhesive force reducing device further comprises the ultraviolet irradiation unit in a suction plate.
